(19) United States
(12) Patent Application Publication
(10) Pub. No.: US 2025/0059475 A1
(43) Pub. Date: Feb. 20, 2025

(54) NEW COATED DETERGENT TABLET

(71) Applicant: EUROTAB OPERATIONS, SAINT JUST SAINT RAMBERT (FR)

(72) Inventors: Jean-Louis ESPEIT, SAINT ETIENNE (FR); Jacques BROSSE, LA GRAND CROIX (FR); Fabrice OFRIDAM, LYON (FR)

(21) Appl. No.: 18/722,676

(22) PCT Filed: Dec. 22, 2022
(86) PCT No.: PCT/FR2022/052486

§ 371 Date: Jun. 21, 2024

(30) Foreign Application Priority Data
Dec. 22, 2021 (FR) FR2114279

(51) Int. Cl. C11D 17/04; C11D 11/00

(52) U.S. Cl. CPC C11D 17/044; C11D 11/00

(57) ABSTRACT

The present invention relates to the field of tablets for household and fabric care, in particular detergent tablets. The invention relates in particular to a tablet coated with an environmentally friendly solution based on a mixture of polymers of natural origin, which makes it possible to prevent the tablets from breaking or flaking during production, transportation and use thereof.

### FIELD OF THE INVENTION

The present invention belongs to the field of tablets for household and fabric care, and in particular detergent tablets. The invention relates, in particular, to a tablet coated by an environmentally friendly solution based on a mixture of polymers of natural origin, which makes it possible to prevent these tablets from fracturing or flaking during their production, transport and use.

### PRIOR ART

Detergents in the form of tablets have many advantages compared with other detergents in the form of a liquid or powder, in particular in terms of their dosage, storage and transport. Detergent tablets are most often prepared by premixing various components, preferably in the form of powders or granules, but also in liquid form. This premix is then compacted using a press in order to form a tablet. Industrially, the use of rotary presses is preferred in order to enable compacted tablets to be formed at high speeds.

These pre-dosed tablets are introduced into a washing machine (typically a dishwasher or a laundry machine) at the start of a washing cycle, and are generally intended to be entirely consumed by the end of the cycle.

The field of detergents imposes particular constraints for forming tablets, since some components do not support compression well, other components may react with them before use and thus reduce the effectiveness of the tablet during use. This is why multilayer tablets have been developed. More specifically, such multilayer tablets can both separate the components which are capable of reacting with one another and the components sensitive to compression are inserted in the last layer so that they are only compressed once. The multilayer tablets may present slightly offset disintegration between the different layers; the first layer having been compressed several times generally has, as a result, a longer disintegration than the subsequent less compressed layers.

Although they have many advantages, such as minimum size and maximum effectiveness, detergent tablets are rather fragile. One of the recurring problems is the strength of these tablets over time, in particular so that they can be handled and transported without falling apart or disintegrating.

Detergent tablets are particularly susceptible to being damaged when they fall on the floor. It has therefore been proposed to provide detergent tablets with a generally individual packaging, in order to improve their mechanical properties of resistance to abrasion and to impacts. Such packaging must act as a physical barrier in order to preserve the integrity of the contents of the packaging, for example against damage from humidity or against damage due to handling of the tablets.

In this regard, it has been proposed to cover the detergent tablets with a water-soluble packaging:
either by a thermoplastic film which may or may not be retractable;
or by spraying with a solution forming a thin film, also referred to as a “coating”.

Teachings relating to the “coating” are found in a patent from Colgate Palmolive published in 1966 under reference U.S. Pat. No. 3,231,505. It is proposed to cover the detergent tablet with a solution of synthetic organic polymer, for example polyvinyl alcohol (PVA), forming a film in order to increase the resistance to abrasion and accidental breaking of the tablet. Another patent, in the name of Dalli-Werke GmbH and Co. KG, published under reference EP 2 045 319, describes a detergent composition coated by spraying, for which the coating is produced by placing a powder coating material in direct contact with the tablet and then equalising the powder particles so that a homogeneous “fused” coating is obtained. The applicant's patent FR3044678 is also known, which proposes greatly improving the efficiency of the packaging of detergent tablets through “coating” by addition of a specific agent aiming to improve efficiency in terms of rinsing.

However, known water-soluble packaging for detergent tablets is not totally satisfactory in terms of ease and efficiency of use, in particular when they are produced from biosourced materials. In particular, the following problems have been noted:
appearance of a significant quantity of undissolved residues at the end of washing, in the interior space of the washing machine;
increase in the dissolution time of the detergent tablet, or in the disintegration time, which extends the duration of the washing cycle;
sticking effect: the tablets adhere to one another and are difficult for the consumer to dissociate;
appearance of crazing in the coating during storage of the tablets.

Hence none of the available detergent tablet packaging that is commercially available and obtained from polymers of natural origin produce a satisfactory compromise between preserving the physical integrity of the tablet on the one hand, and its efficiency on the other hand.

Therefore, a need remains to provide coated tablets overcoming the problems of the prior art, in particular to provide tablets coated by means of a mixture of polymers of natural origin, the strength of which is improved in order that the tablets do not fracture or flake during their production, transport and use. An additional objective is to ensure that the tablets packaged by biosourced polymers, that are more environmentally friendly, do not adhere to one another and are easily dissociated, for example when they are stacked one on top of the other or against one another in a storage space. Particular attention is also paid to the dissolution and disintegration times of the tablet, to the desired absence of non-dissolved residues and to the preservation of the efficiency of the product contained in the tablet.

### SUMMARY OF THE INVENTION

The invention relates to a coated tablet for household and fabric care, with a water-soluble covering obtained by spraying a solution comprising a biosourced film-forming agent composed of the mixture of a polysaccharide, preferably a starch, and at least one protein, water and optionally a humectant, the biosourced protein film-forming agent being chosen from plant proteins, animal proteins and the mixtures thereof.

More particularly, an object of the present invention is a coated tablet for household and fabric care comprising a body formed from compacted powder, the body being coated with a water-soluble covering comprising:
a) a biosourced film-forming agent composed of the mixture of a polysaccharide, preferably a starch, and at least one protein, said protein being chosen from animal proteins, plant proteins and the mixtures thereof, the proportion by mass of proteins in said film-forming agent being greater than or equal to 1% and less than 50%, preferably ranging from 1% to 30%;
b) optionally a humectant;
c) water;
wherein the ratio by mass (biosourced film-forming agent/humectant) is between 1 and 30, ideally between 2 and 20 when the humectant is present.

The present invention also relates to a method for producing a coated tablet for household and fabric care, comprising a body coated with a water-soluble covering, said method comprising the following steps:
(1) providing a body formed from compacted powder;
(2) spraying the surface of the body with a solution comprising:
a) from 2% by mass to 80% by mass of a biosourced film-forming agent composed of the mixture of a polysaccharide, preferably a starch, and at least one protein, relative to the total mass of the solution, said protein being chosen from animal proteins, plant proteins and the mixtures thereof, the proportion by mass of proteins in said biosourced film-forming agent being greater than or equal to 1% and less than 50%, preferably ranging from 1% to 30%;
b) at least 20% by mass of water relative to the total mass of the solution; and
c) optionally, a humectant;
the ratio by mass (biosourced film-forming agent/humectant) in said solution being between 1 and 30 when the humectant is present.

Other aspects of the invention are as described below and in the claims.

### DETAILED DESCRIPTION OF THE INVENTION

The inventors have developed tablets responding to the stated needs. For this purpose, the present invention relates to a coated tablet for household and fabric care, comprising a body formed from compacted powder, said body being coated with a water-soluble covering obtained by spraying the surface of said body with a solution comprising:
a) from 2% to 80% by mass or from 5% to 70% by mass, preferably from 30% to 70% or from 30% to 50% by mass, of a biosourced film-forming agent composed of the mixture of a polysaccharide, preferably a starch, and at least one protein, relative to the total mass of the solution, said protein being chosen from animal proteins, plant proteins and the mixtures thereof, the proportion by mass of proteins in said biosourced film-forming agent being greater than or equal to 1% and less than 50%, preferably ranging from 1% to 30%, still more preferably from 2% to 20%;
b) at least 20% or at least 30%, preferably at least 50%, by mass of water relative to the total mass of the solution; and
c) optionally, a humectant;
the ratio by mass (biosourced film-forming agent/humectant) in said solution being between 1 and 30 when the humectant is present.

The term “tablet for household and fabric care” as used here designates compositions in the form of a compacted solid intended for household and fabric care.

The compacted solid compositions consist of an assembly of grouped particles having sufficient cohesion to be handled without breaking and which disintegrate easily in water. One or more of these tablets, when they are added to a prescribed quantity of water, provide an appropriate solution for carrying out a domestic cleaning operation, such as cleaning floors, walls, bathroom or kitchen surfaces, crockery or a laundry cleaning or care operation. The tablets can be used, for example, for preparing a refill solution of household products (“refill tablet”). Thus, the tablets for household and fabric care can be tablets suitable for washing laundry, crockery or any other domestic cleaning operation which involves dissolving the tablet in an aqueous medium. Such tablets can be designated by the generic term “detergent tablet”. The tablets for fabric care in particular can be tablets intended for laundry washing or laundry care (“softener tablet”).

The tablets do not need to have a high hardness, their cohesion and mechanical strength being, in particular, reinforced by the use of a covering which coats the tablet, in other words adheres to the surface of the tablet.

Surprisingly, it has been observed that a tablet for household and fabric care, in particular a detergent tablet, coated with the covering of the invention, is very satisfactory in terms of washing efficiency, disintegration time, absence of washing residues, as well as ease of storage. In addition, the coated tablet thus produced does not adhere on contact to other tablets or other elements present. Furthermore, no appearance of crazing is observed on the coating during storage of the tablets, only some small cracks can sometimes be observed for high concentrations by mass of proteins. The integrity of the tablet is therefore preserved, the covering does not fall apart.

The covering obtained according to the invention very effectively protects the tablet against abrasion and impacts, as well as against humidity damage and damage due to handling of said tablet.

Furthermore, such a solution is environmentally friendly.

The production of such a tablet does not therefore require the use of a thermoplastic film, but simply the use of a particular solution, in order to form the water-soluble covering intended to cover the surface of the tablet by simple spraying.

The tablet for household and fabric care may be a coated detergent tablet, most particularly a dishwasher detergent tablet.

The various components of the proposed tablet can be as described below.

### Body

The tablet has a body formed by compaction of powder. It is understood that the expression “body formed from compacted powder” does not exclude the possibility that the body comprises liquids. Typically, the body is formed by a mixture of raw materials in solid form (powder) and optionally one or more raw materials in liquid form.

The term “powder” is understood, in the sense of the present invention, to mean a material in the form of solid particles. In the context of the present invention, the term powder thus includes materials in the form of granules.

The body of the tablet can be composed of a single layer or a stack of several layers which are superposed on one another, thus forming a uniform and compact block. For a multilayer tablet, the various layers can have an identical or different composition.

The body of the tablet preferably has an elongate shape with a cross-section having any shape, for example circular, oval, octagonal or parallelepiped. When the cross-section of the tablet is parallelepiped, typically square or rectangular, the corners of the tablet can be curved so as to be less brittle.

The body of the detergent tablets is generally composed of a mixture of components exerting different actions, these components can, for example, be chosen from surfactants, fillers, sequestrants, bleaching agents, enzymes, bleach activators, alkaline agents, polymers, perfumes, dyes, tableting additives (binders, lubricants), descaling agents, corrosion inhibitors, catalysts, bursting agents, etc.

The tablet preferably has a mass ranging from 1 gram to 100 grams, preferably ranging from 5 grams to 50 grams. The tablet preferably has a mechanical strength ranging from 5 Newtons to 300 Newtons, preferably ranging from 10 Newtons to 90 Newtons.

### Water-Soluble Covering and Spraying Solution

The water-soluble covering is obtained by spraying a solution comprising a biosourced film-forming agent, water and optionally a humectant. Once the sprayed solution is dried, the outer surfaces of the body of the tablet are entirely covered with a water-soluble thin film (the water-soluble covering), also called “coating”, adhering to the surface thereof.

### Biosourced Film-Forming Agent

The biosourced film-forming agent is composed of the mixture of a polysaccharide, preferably a starch, and at least one protein, the protein being chosen from plant proteins, animal proteins and the mixtures thereof. It is understood that the animal proteins can be in the form of mixtures of different animal proteins and that the plant proteins can be in the form of mixtures of different plant proteins.

The polysaccharides and proteins that are useful in the context of the present invention are typically water-dispersible or water-soluble compounds. In particular, the polysaccharides and proteins that are useful in the context of the present invention are typically water-soluble at the temperature of use of the tablets (typically from 30 to 60° C.).

Examples of animal proteins include, in a non-limiting manner, lacto-proteins (such as casein), albumins and globulins. The animal proteins can be extracted from milk, eggs or be insect proteins.

Examples of plant proteins include, in a non-limiting manner, albumins, globulins, prolamins, glutelins and the mixtures thereof. More particularly, the plant proteins that are useful in the context of the present invention include gluten. Gluten is composed of prolamins and glutelins. The plant proteins can be extracted from a wide variety of plants, including algae.

In certain embodiments, the biosourced film-forming agent is composed of the mixture of a polysaccharide, preferably a starch, and at least one protein, the protein being chosen from plant proteins and the proportion by mass of proteins in the film-forming agent is greater than or equal to 1% and less than 50%, preferably ranging from 1% to 30%. In these embodiments, the protein/proteins is/are therefore a plant protein/plant proteins. In other words, in these embodiments, the biosourced film-forming agent is composed of the mixture of a polysaccharide, preferably a starch, and one or more plant proteins, the proportion by mass of plant proteins in the film-forming agent being greater than or equal to 1% and less than 50%, preferably ranging from 1% to 30%.

In certain embodiments, the biosourced film-forming agent is therefore advantageously composed of the mixture of a polysaccharide, preferably a starch, and at least one protein chosen from lacto-proteins, albumins, globulins, prolamins, glutelins and the mixtures thereof. In the context of the invention, the biosourced film-forming agent will preferably be 100% of plant origin.

In certain embodiments, the biosourced film-forming agent is composed of the mixture of a starch and at least one plant protein chosen from albumins, globulins, prolamins, glutelins and the mixtures thereof, preferably gluten.

In certain embodiments, the biosourced film-forming agent is composed of the mixture of starch and gluten.

It is well known to a person skilled in the art that polysaccharides, sometimes called complex carbohydrates, are polymers composed of several sugars bonded together by osidic bonds. Among the most widespread polysaccharides in the plant kingdom are starches (wheat starch, corn starch, etc.). Starch is a polysaccharide, namely a natural polymer, composed of D-glucose units. It acts as a reserve for higher plants and is a common element of the human diet found, among other things, in flours.

The spraying solution comprises 2% to 80% by mass or 5% to 70%, preferably 30 to 70%, by mass of a biosourced film-forming agent, such as described above. The proportion by mass of proteins in the biosourced film-forming agent is greater than or equal to 1% and less than 50%, preferably it varies from 1% to 30%, preferably 2% to 20%.

In certain embodiments, the water-soluble covering and/or the solution do not comprise any film-forming agent other than the biosourced film-forming agent.

In certain embodiments, the solution can comprise, in addition to the biosourced film-forming agent, a conventional film-forming agent.

### Humectant

The humectant is optional. The humectant is typically chosen from the polyols, such as for example glycerol or sorbitol or mannitol, certain sugars and their derivatives and (poly)ethylene glycols and the combinations thereof. In the context of the present invention, the sugar may be, in particular, a monosaccharide (e.g., fructose, glucose, dextrose, etc.), a disaccharide (e.g., sucrose, for example in the form of cane sugar), or a mixture of these (for example in the form of agave syrup). The humectant is preferably glycerol, advantageously of plant origin.

When the solution comprises a humectant, the ratio by mass (biosourced film-forming agent/humectant) in the solution is between 1 and 30, advantageously between 2 and 20.

In certain preferred embodiments, the humectant is used in a proportion less than 10% by mass relative to the total mass of the solution, advantageously less than 5%.

### Other Optional Ingredients

The water-soluble covering can comprise additional conventional ingredients. Thus, these additional conventional ingredients can be added to the solution to be sprayed. When such additional conventional ingredients are present, their total mass does not exceed 10% of the mass of the solution. These ingredients include, by way of example: thixotropic agents, anti-spotting and/or anti-filming agents, preservatives, surfactants and polymers (PVA . . . ), perfumes and dyes, etc.

Thus, in certain embodiments, the solution comprises:
a) from 2% to 80% by mass or from 5% to 70% by mass, preferably from 30% to 70% by mass relative to the total mass of the solution, of a biosourced film-forming agent composed of the mixture of a polysaccharide, preferably a starch, and at least one protein relative to the total mass of the solution, the proportion by mass of proteins in said biosourced film-forming agent being greater than or equal to 1% and less than 50%, preferably ranging from 1% and 30%, preferably 2% to 20%;
b) at least 20%, preferably at least 50%, by mass of water relative to the total mass of the solution;
c) from 0 to 10% by mass of a humectant relative to the total mass of the solution;
d) from 0 to 10% by mass of conventional ingredients, such as the above mentioned ingredients, relative to the total mass of the solution;
the sum of the percentages of the components (a) to (d) being equal to 100%.

When the humectant is employed, the ratio by mass (biosourced film-forming agent/humectant) in the solution is between 1 and 30, advantageously between 2 and 20.

The thickness of the covering deposited on the surface of the body of the tablet after drying, is for example between 0.05 μm and 1000 μm, preferably between 5 μm and 300 μm, and more preferably between 15 μm and 200 μm. The water-soluble covering deposited on the body of the tablet, before drying, preferably represents between 0.3% and 20% of the total mass of the detergent tablet, and more preferably between 2% and 10% of the total mass of the detergent tablet.

The water-soluble covering after drying, for example the water-soluble covering of the tablets ready to be packaged and marketed, or the covering of the packaged tablets, comprises:
a) a biosourced film-forming agent composed of the mixture of a polysaccharide, preferably a starch, and at least one protein, said protein being chosen from animal proteins, the plant proteins and the mixtures thereof, the proportion by mass of proteins in said film-forming agent being greater than or equal to 1% and less than 50%, preferably ranging from 1% à 30%, preferably from 2% to 20%;
b) water;
c) optionally a humectant;
wherein the ratio by mass (biosourced film-forming agent/humectant) is between 1 and 30, ideally between 2 and 20 when the humectant is present.

Depending on the drying performed, the water-soluble covering after drying can comprise from 5% to 60% water by mass relative to the mass of the water-soluble covering.

In other words, the coated tablets of the present invention comprise:
(1) a body formed from compacted powder;
(2) a water-soluble covering, typically sprayed on the surface of the body, the water-soluble covering comprising:
a) a biosourced film-forming agent composed of the mixture of a polysaccharide, preferably a starch, and at least one protein relative to the total mass of the solution, said protein being chosen from animal proteins, plant proteins and the mixtures thereof, the proportion by mass of proteins in said film-forming agent being greater than or equal to 1% and less than 50%, preferably ranging from 1% to 30%, preferably from 2% to 20%;
b) water;
c) optionally a humectant;
wherein the ratio by mass (biosourced film-forming agent/humectant) is between 1 and 30, ideally between 2 and 20 when the humectant is present.

Depending on the drying performed, the water-soluble covering after drying can comprise from 5% to 60% water by mass relative to the mass of the water-soluble covering.

In the coated tablets of the present invention, the proteins are preferably plant proteins (one plant protein or a mixture of different plant proteins).

### Production of a tablet

The present invention also relates to a method for producing a coated tablet as previously described, said tablet comprising a body formed from compacted powder, the body being coated with a water-soluble covering. The method comprises a step of spraying, on the surface of the body, a solution comprising:
a) from 2% to 80% by mass or from 5% by mass to 70% by mass, preferably from 30% to 70% by mass or from 30% to 50% by mass, of a biosourced film-forming agent composed of the mixture of a polysaccharide, preferably a starch, and at least one protein, relative to the total mass of the solution, said protein being chosen from animal proteins, plant proteins and the mixtures thereof, the proportion by mass of proteins in said film-forming agent being greater than or equal to 1% and less than 50%, preferably ranging from 1% and 30%, preferably from 2% to 20%;
b) optionally a humectant; and
c) at least 20% by mass or at least 30%, preferably at least 50%, of water relative to the total mass of the solution;
wherein the ratio by mass (biosourced protein film-forming agent/humectant) is between 1 and 30, advantageously between 2 and 20 when the humectant is present.

In other words, the present invention relates to a method for producing a detergent tablet coated with a water-soluble covering, the method comprising the following steps:
(1) providing a tablet body formed from compacted powder;
(2) spraying the surface of the body with a solution comprising:
a) from 2% to 80% by mass or from 5% to 70% by mass, preferably from 30% to 70% by mass or from 30% to 50% by mass, of a biosourced film-forming agent composed of the mixture of a polysaccharide, preferably a starch, and at least one protein, relative to the total mass of the solution, said protein being chosen from animal proteins, plant proteins and the mixtures thereof, the proportion by mass of proteins in said film-forming agent being greater than or equal to 1% and less than 50%, preferably ranging from 1% and 30%, preferably from 2% to 20%;
b) at least 20% or at least 30%, preferably at least 50%, by mass of water relative to the total mass of the solution; and
c) optionally, a humectant,
wherein the ratio by mass (biosourced protein film-forming agent/humectant) is between 1 and 30, advantageously between 2 and 20 when the humectant is present.

The solution can be as described in more detail above.

The solution will be sprayed one or more times. The total quantity of sprayed solution can vary from 25 g/m² to 1000 g/m², in particular from 100 g/m² to 350 g/m² taking into account the surface area of detergent tablet to be covered. By way of example, 0.6 g of solution can be used to cover a 16-gram rectangular detergent tablet having a surface to be covered of 3397 mm².

The spraying is typically carried out at ambient temperature using a nozzle system.

The method can further comprise one or more drying steps. The drying can be carried out using hot or unheated air or, for example, by infrared radiation. The drying is typically carried out in such a way that the tablet is dry to the touch. Preferably, the drying leads to a reduction by half in the mass of the sprayed solution (evaporation of all or part of the water).

In certain embodiments, the method comprises two, three or more sequences of spraying and drying steps.

After drying, the coated tablet can be packaged.

The present invention also relates to the coated tablets that can be obtained by such methods.

The examples which follow are given by way of illustration. These examples in no way limit the present invention.

### EXAMPLES

### Example 1: Preparation of the Solutions to Be Sprayed

The coating solutions produced for all the tests presented below have been formulated from the following raw materials:
biosourced film-forming agent:
   “algae”: composition from algae comprising 95% by weight starch and 5% by weight protein
   “flour”: wheat flour comprising 12% by weight gluten
   “starch”: potato starch
   “gluten”: wheat gluten
humectant: glycerol of plant origin;
preservative: potassium sorbate.

The production of the coated tablets, for which the operating conditions are detailed in the table below, proceeds furthermore in the following fashion:

In a first step, the preservative is dissolved in water at ambient temperature, and a mechanical stirring performed using a propeller stirrer at an average speed of 500 rpm.

Once its total dissolution is observed, the biosourced film-forming agent dissolves in turn in the mixture previously obtained.

Finally, glycerol (when present) is added to the obtained mixture, and the mechanical stirring is continued for a duration of 5 min in order to ensure good dispersion of the glycerol within the thus formed solution.

The following solutions to be sprayed (table 1) were prepared:

TABLE 1
Solutions to be sprayed. The percentages are expressed
by mass relative to the total mass of the solution

| | Solutions to be sprayed | | | | | | | | |
|---|---|---|---|---|---|---|---|---|---|
| | INV1 | INV2 | INV3 | INV4 | INV5 | INV6 | HI1 | HI2 | HI3 |
| Plant | Gluten | Gluten | Gluten | Algae | Algae | Flour | — | Gluten | Gluten |
| protein(%) | 1 | 3.9 | 8.5 | 42 | 42 | 37.7 | | 21.25 | 21.25 |
| Starch (%) | Starch | Starch | Starch | | | | Starch | Starch | Starch |
| | 41.5 | 39 | 34 | | | | 42.5 | 21.25 | 21.25 |
| Humectant | 4 | 4 | 4 | 4 | — | 4 | 4 | 4 | — |
| (%) | | | | | | | | | |
| Water (%) | 51 | 50.6 | 51.6 | 51.5 | 55.5 | 55.8 | 51 | 51 | 55 |
| Preservative | 2.5 | 2.5 | 2.5 | 2.5 | 2.5 | 2.5 | 2.5 | 2.5 | 2.5 |
| (%) | | | | | | | | | |

### Example 2: Spraying of the Solution in Order to Coat the Tablet

The tablet is deposited beforehand on a perforated grid, then a first phase of spraying is carried out using an air gun on the 5 visible faces of said tablet: the adjustments are such that the dosage presented in the tables below is deposited on the surface of the tablet.

This is followed by a drying step carried out in an oven regulated at a temperature of 37° C., and this for a duration of 15 min.

Once the drying operation is performed, the tablet is turned over and sprayed again on the 5 visible faces: the sides of the tablet are consequently sprayed twice, in such a way as to finally received the same quantity of solution as the flat faces.

Finally, the drying operation is repeated in an oven at 37° C., for a duration of 15 min: the quality of the drying is then verified by simply touching the coated tablet, which must not be damp.

### Example 3: Properties of the Coated Tablets

### 3.1 Analysis Methods

### 3.1.1 Disintegration Time

The disintegration time of the tablets was measured a short while after coating and drying of the tablets (t0) and after accelerated ageing of the tablets under conditions simulating a storage for two years under user conditions (4 weeks at 38° C. with a relative humidity of 46% are equivalent to 2 years at ambient temperature and humidity).

The disintegration time of a tablet is measured using a piece of equipment which moves back and forward at a frequency of 60 strokes/min. The tablet is placed in a basket provided with multiple holes in order to allow the water to drain. The basket is then immersed in a beaker containing a volume of 1.8 L of water at 30° C. The disintegration time is recorded once the tablet is completely disintegrated, and once there is no more tablet residue in the basket.

In order to be judged “compliant”, the disintegration time of a dishwasher detergent tablet must be less than 15 minutes in order to obtain an optimum washing efficiency.

In order to be judged “compliant”, the disintegration time of a laundry machine detergent tablet must be less than 10 minutes in order to obtain an optimum washing efficiency.

In order to be judged “compliant”, the disintegration time of a softener tablet for laundry washing must be less than 15 minutes in order to obtain an optimum washing efficiency.

### 3.1.2 Hardness

The hardness (strength) of the tablets was measured a short time after coating and drying of the tablets (t0) and after accelerated ageing of the tablets under conditions simulating ageing of two years.

The hardness of the tablets is measured using a durometer. A force is applied on the tablet using a cylinder, and its corresponding strength is indicated by reading directly in Newtons via a data exploitation system. This strength varies from one type of tablet to another.

### 3.1.3 Friability

The friability of the tablets was measured a short time after coating and drying of the tablets (t0) and after accelerated ageing of the tablets under conditions simulating ageing for two years under user conditions.

The friability of a tablet is measured by placing 3 tablets in a closed plastic wheel. The rotation of the wheel reproduces the impacts of the conditioning of the production lines. The fragility of the tablets is measured by weighing the tablets after 50 rotations.

The friability is the percentage mass loss before/after test.

### 3.1.4 General Appearance

The general appearance of the tablet is evaluated at the end of the drying operation of the tablet at t0.

A visual evaluation enables the presence or absence of crazing of the covering to be verified, characterised by the presence of cracks at the surface of the tablet.

An evaluation by simply touching enables the surface of the tablet to be characterised (smooth, grainy, dusty, non-dusty).

### 3.2 Results

### 3.2.1 Dishwasher Detergent Tablet

In order to test the properties of the coated detergent tablets according to the invention, coating tests according to the method described above were carried out in the laboratory on three-layer detergent tablets of mass 16 g, with rectangular shape and dimensions 36 mm (length)×26 mm (width)×12 mm (thickness), for use in dish-washing, manufactured using a rotary press. The compositions of layers 1, 2 and 3 are given in tables 2 to 4 respectively.

TABLE 2
Composition of layer 1

| Raw materials | Percentage by weight |
|---|---|
| Sodium citrate | 46.00 |
| Sodium carbonate | 22.92 |
| Sodium chloride | 1.37 |
| Sodium percarbonate | 19.18 |
| Non-ionic surfactant | 2.50 |
| Ionic surfactant | 3.13 |
| Polyethylene glycol | 4.50 |
| Glycerol | 0.30 |
| Dye | 0.10 |
| TOTAL | 100.00 |

TABLE 3
Composition of layer 2

| Raw materials | Percentage by weight |
|---|---|
| Sodium citrate | 46.00 |
| Sodium carbonate | 22.92 |
| Sodium chloride | 1.47 |
| Sodium percarbonate | 19.18 |
| Non-ionic surfactant | 2.50 |
| Ionic surfactant | 3.13 |
| Polyethylene glycol | 4.50 |
| Glycerol | 0.30 |
| TOTAL | 100.00 |

TABLE 4
Composition of layer 3

| Raw materials | Percentage by weight |
|---|---|
| Sodium citrate | 40.90 |
| Sodium carbonate | 34.43 |
| Sodium chloride | 2.54 |
| Non-ionic surfactant | 2.30 |
| Ionic surfactant | 2.50 |
| Catalyst | 1.60 |
| Amylase | 3.65 |
| Protease | 7.00 |
| Polyethylene glycol | 4.50 |
| Glycerol | 0.30 |
| Dye | 0.10 |
| Perfume | 0.18 |
| TOTAL | 100.00 |

The results obtained are presented in tables 5 and 6.

TABLE 5
Evaluation of the tablets according to the invention

| Sprayed solution | | INV1 | INV2 | INV2 | INV3 | INV4 | INV5 | INV6 |
|---|---|---|---|---|---|---|---|---|
| Dosage before drying | | 200 | 100 | 200 | 200 | 200 | 200 | 200 |
| (g/m²) | | | | | | | | |
| Dosage after drying | | 100 | 50 | 100 | 100 | 100 | 100 | 100 |
| (g/m²) | | | | | | | | |
| | | T0 | | | | | | |
| Disintegration (time) | | 8 min | 4 min 10 | 8 min | 8 min | 8 min | 8 min | 8 min |
| | | 15 s | S | 20 s | 10 s | | | 10 s |
| Hardness (N) | | 210 | 155 | 225 | 210 | 220 | 180 | 240 |
| Friability (%) | | 1.5 | 2 | 0.07 | 1 | 0.02 | 2.5 | 0.05 |
| Appearance | Surface area | Smooth | Rough | Smooth | Smooth | Smooth | Smooth | Smooth |
| | Dusty | NO | NO | NO | NO | NO | NO | NO |
| | Crazing | NO | NO | NO | Some | NC | NO | NO |
| | | | | | cracks | | | |

| | | Ageing | | | | | |
|---|---|---|---|---|---|---|---|
| Disintegration (time) | 8 min | 4 min 10 | 8 min | 8 min | 7 min | 7 min | 7 min |
| | 20 s | S | 05 s | 15 s | 50 s | 50 s | 50 s |
| Hardness (N) | 200 | 150 | 225 | 195 | 230 | 155 | 230 |
| Friability (%) | 1.5 | 2 | 0.05 | 3.2 | 0.02 | 8.5 | 0.05 |

TABLE 6
Evaluation of tablets not according to invention

| Sprayed solution | HI1 | | HI2 | | HI3 | | Ref | |
|---|---|---|---|---|---|---|---|---|
| Dosage before drying | 200 | | 200 | | 200 | | — | |
| (g/m²) | | | | | | | | |
| Dosage after drying | 100 | | 100 | | 100 | | — | |
| (g/m²) | | | | | | | | |
| | T0 | | | | | | | |
| Disintegration | 8 | min | 8 | min | 8 | min | 3 | min |
| (time) | 15 | s | 20 | s | 20 | s | 15 | s |

| Hardness (N) | | 180 | 180 | 120 | 81 |
|---|---|---|---|---|---|
| Friability (%) | | 12 | 3.8 | 12 | 35 |
| Appearance | Surface | Rough | Rough | Rough | |
| | area | | | | |
| | Dusty | YES | YES | YES | YES |
| | | (+++) | | | |
| | Crazing | NO | YES | YES | |
| | | | (+++) | (+++) | |

| | Ageing | | | | | | | |
|---|---|---|---|---|---|---|---|---|
| Disintegration | 8 | min | 8 | min | 8 | min | 3 | min |
| (time) | 10 | s | 20 | s | 20 | s | | |

| | | | | |
|---|---|---|---|---|
| Hardness (N) | 170 | 170 | 130 | 75 |
| Friability (%) | 19 | 9.5 | 13 | 43 |

Dusty: +++: surface very dusty
Crazing: +++: many cracks very visible

Surprisingly, it is observed that the combination of starch and proteins makes it possible to obtain a homogeneous and solid coating after drying, enabling good protection of the tablet, and this from low doses of proteins.

### 3.2.2 Tablet for Care of Laundry (Softening)

In order to test the properties of the coated tablets according to the invention, coating tests according to the method described above were carried out in the laboratory on tablets of mass 12 g, with rectangular shape and dimensions 36 mm (length)×26 mm (width)×12 mm (thickness), for use in laundry washing, manufactured using a rotary press. The body of the tablets in these tests was of the same composition.

The results obtained are presented in table 7.

TABLE 7
Evaluation of tablets according to the invention and not according to the invention

| Sprayed solution | | Re | INV2 | INV3 | INV4 | INV6 | HI1 | HI3 |
|---|---|---|---|---|---|---|---|---|
| Dosage before drying | | — | 180 | 180 | 180 | 180 | 180 | 180 |
| (g/m²) | | | | | | | | |
| Dosage after drying | | — | 90 | 90 | 90 | 90 | 90 | 90 |
| (g/m²) | | | | | | | | |
| | | T0 | | | | | | |
| Disintegration (time) | | 45 min | 42 min | 42 min | 48 min | 50 min | 47 min | 43 min |
| Hardness (N) | | 200 | 280 | 255 | 320 | 290 | 220 | 200 |
| Friability (%) | | 2 | 0.5 | 0.6 | 0 | 0.5 | 2.5 | 2 |
| Appearance | Surface area | Smooth | Smooth | Rough | Very | Very | Rough | Rough |
| | | | | | smooth | smooth | | |
| | Dusty | YES | NO | NO | NO | NO | YES | YES |
| | | | | | | | (+++) | |
| | Crazing | NO | NO | Some | NO | NO | NO | YES |
| | | | | small | | | | (+++) |
| | | | | cracks | | | | |

| | Ageing | | | | | | |
|---|---|---|---|---|---|---|---|
| Disintegration (time) | 45 min | 41 min | 43 min | 46 min | 48 min | 42 min | 44 min |
| Hardness (N) | 180 | 275 | 235 | 300 | 290 | 220 | 210 |
| Friability (%) | 3 | 0.4 | 1 | 0 | 0.2 | 2.3 | 2.6 |

Dusty: +++: surface very dusty
Crazing: +++: many cracks very visible
“Ref” designates a tablet of the same composition without coating

### 3.2.3 Tablet for Washing Laundry

In order to test the properties of the coated tablets according to the invention, coating tests according to the method described above were carried out in the laboratory on tablets of mass 20 g, with rectangular shape and dimensions 36 mm (length)×26 mm (width)×12 mm (thickness), for use in laundry washing, manufactured using a rotary press. The body of the tablets in these tests was of the same composition.

The results obtained are presented in table 8.

TABLE 8
Evaluation of tablets according to the invention and not according to the invention

| Sprayed solution | | Ref | INV2 | INV3 | HI2 | HI1 | INV6 | INV4 |
|---|---|---|---|---|---|---|---|---|
| Dosage before | | — | 250 | 250 | 250 | 250 | 250 | 250 |
| drying (g/m²) | | | | | | | | |
| Dosage after drying | | — | 125 | 125 | 125 | 125 | 125 | 125 |
| (g/m²) | | | | | | | | |
| | | T0 | | | | | | |
| Disintegration | | 3 min | 3 min | 3 min | 3 min | 3 min | 3 min | 3 min |
| (time) | | | 15 s | 15 s | 10 s | 20 s | 15 s | 30 s |
| Hardness (N) | | 71 | 205 | 190 | 90 | 90 | 200 | 220 |
| Friability (%) | | 26.8 | 1.3 | 4.2 | 12 | 22 | 1.5 | 1 |
| Appearance | Surface area | Rough | Smooth | Smooth | Rough | Rough | | |
| | Dusty | YES | NO | NO | YES | YES | NO | NO |
| | | | | | | (+++) | | |
| | Crazing | NO | NO | Some | YES | NO | NO | NO |
| | | | | cracks | (+++) | | | |

| | Ageing | | | | | | |
|---|---|---|---|---|---|---|---|
| Disintegration | 3 min | 3 min | 3 min | 3 min | 3 min | 3 min | 3 min |
| (time) | 10 s | 25 s | 25 s | 10 s | 40 s | 30 s | 50 s |
| Hardness (N) | 65 | 175 | 165 | 85 | 80 | 180 | 195 |
| Friability (%) | 28 | 1.8 | 6.2 | 15 | 24 | 1.8 | 1.2 |

Dusty: +++: surface very dusty
Crazing: +++: many cracks very visible
“Ref” designates a tablet of the same composition without coating

### 3.2.4 Refill Tablet

In order to test the properties of the coated tablets according to the invention, coating tests according to the method described above were carried out in the laboratory on tablets of mass 5 g, with rectangular shape and dimensions 36 mm (length)×26 mm (width)×12 mm (thickness), manufactured using a rotary press. The body of the tablets in these tests was of the same composition.

The results obtained are presented in table 9.

TABLE 9
Evaluation of tablets according to the invention and not according to the invention

| Sprayed solution | | Ref | INV2 | INV3 | HI2 | HI1 | INV6 | INV4 |
|---|---|---|---|---|---|---|---|---|
| Dosage before | | — | 180 | 180 | 180 | 180 | 180 | 180 |
| drying (g/m²) | | | | | | | | |
| Dosage after drying | | — | 90 | 90 | 90 | 90 | 90 | 90 |
| (g/m²) | | | | | | | | |
| | | T0 | | | | | | |
| Disintegration (time) | | 3 min | 3 min | 3 min | 3 min 50 | 3 min | 3 min | 3 min |
| | | | 15 s | 20 s | S | 15 s | 15 s | 10 s |
| Hardness (N) | | 80 | 115 | 120 | 95 | 95 | 115 | 120 |
| Friability (%) | | 5 | 0.7 | 1.5 | 3.8 | 4.2 | 0.8 | 0 |
| Appearance | Surface area | Smooth | Smooth | Rough | Rough | Rough | Very | Very |
| | | | | | | | smooth | smooth |
| | Dusty | YES | NO | NO | YES | YES | NO | NO |
| | | | | | | (+++) | | |
| | Crazing | — | NO | Small | YES | NO | NO | NO |
| | | | | cracks | (+++) | | | |

| | Ageing | | | | | | |
|---|---|---|---|---|---|---|---|
| Disintegration (time) | 4 min | 3 min | 3 min | 3 min | 3 min | 3 min | 3 min |
| | | 40 s | 20 s | 20 s | 40 s | 40 s | 40 s |
| Hardness (N) | 75 | 115 | 120 | 90 | 85 | 120 | 115 |
| Friability (%) | 5 | 0.9 | 1.5 | 4.1 | 4.9 | 0.9 | 0.2 |

Dusty: +++: surface very dusty
Crazing: +++: many cracks very visible
“Ref” designates a tablet of the same composition without coating

1. A coated tablet for household and fabric care comprising a body formed from compacted powder, said body being coated with a water-soluble covering comprising:
a) a biosourced film-forming agent composed of a mixture of a polysaccharide and at least one protein, said protein being chosen from animal proteins, plant proteins and the mixtures thereof, the proportion by mass of proteins in said film-forming agent being greater than or equal to 1% and less than 50%;
b) optionally a humectant;
c) water;
wherein the ratio by mass (biosourced film-forming agent/humectant) is between 1 and 30 when the humectant is present.

2. The coated tablet according to claim 1, wherein the protein is a plant protein.

3. The coated tablet according to claim 1, wherein the protein is a plant protein and the plant protein is chosen from albumins, globulins, prolamins, glutelins and the mixtures thereof.

4. The coated tablet according to claim 1, wherein the biosourced film-forming agent consists of the mixture of a starch and at least one plant protein chosen from albumins, globulins, prolamins, glutelins and the mixtures thereof.

5. The tablet according to claim 1, wherein the proportion by mass of proteins in said film-forming agent varies from 2% to 20%.

6. The tablet according to claim 1, chosen from laundry machine tablets, dishwasher tablets, softening tablets or refill tablets.

7. A method for producing a coated tablet for household and fabric care comprising a body coated with a water-soluble covering, said method comprising the following steps:
(1) providing a body formed from compacted powder;
(2) spraying the surface of the body with a solution comprising:
a) from 2% by mass to 80% by mass of a biosourced film-forming agent composed of a mixture of a polysaccharide and at least one protein, relative to the total mass of the solution, said protein being chosen from animal proteins, plant proteins and the mixtures thereof, the proportion by mass of proteins in said biosourced film-forming agent being greater than or equal to 1% and less than 50%;
b) at least 20% by mass of water relative to the total mass of the solution; and
c) optionally, a humectant;
the ratio by mass (biosourced film-forming agent/humectant) in said solution being between 1 and 30 when the humectant is present.

8. The method according to claim 7, wherein the protein is a plant protein.

9. The method according to claim 7, wherein the protein is a plant protein and the plant protein is chosen from albumins, globulins, prolamins, glutelins and the mixtures thereof.

10. The method according to claim 7, wherein the biosourced film-forming agent is composed of the mixture of a starch and at least one plant protein chosen from albumins, globulins, prolamins, glutelins and the mixtures thereof.

11. The method according to claim 7, further comprising a drying step.

12. The method according to claim 7, wherein the total quantity of sprayed solution varies from 25 g/m² to 1000 g/m².

13. The coated tablet according to claim 1, wherein the protein is a plant protein and the plant protein is gluten.

14. The coated tablet according to claim 1, wherein the polysaccharide is a starch.

15. The coated tablet according to claim 1, wherein the biosourced film-forming agent consists of the mixture of a starch and gluten.

16. The coated tablet according to claim 1, wherein the proportion by mass of proteins in the film-forming agent ranges from 1% to 30%.

17. The coated tablet according to claim 1, wherein the ratio by mass (biosourced film-forming agent/humectant) is between 2 and 20 when the humectant is present.

18. The method according to claim 7, wherein the proportion by mass of proteins in the biosourced film-forming agent ranges from 1% to 30%.
